(19) United States
(12) Patent Application Publication
(10) Pub. No.: US 2014/0088850 A1
(43) Pub. Date: Mar. 27, 2014

(54) METHOD FOR OPERATING A LONGITUDINALLY GUIDING DRIVER ASSISTANCE SYSTEM OF A MOTOR VEHICLE AND MOTOR VEHICLE

(71) Applicant: Stefan Schuberth, Gaimersheim (DE)

(72) Inventor: Stefan Schuberth, Gaimersheim (DE)

(73) Assignee: Audi AG, Ingolstadt (DE)

(21) Appl. No.: 14/119,702

(22) PCT Filed: May 8, 2012
(86) PCT No.: PCT/EP2012/001961

§ 371 Date: Nov. 22, 2013

(30) Foreign Application Priority Data
May 25, 2011 (DE) 10 2011 102 426.7

(51) Int. Cl. B60W 30/16

(52) U.S. Cl. CPC B60W 30/16
USPC 701/93

(57) ABSTRACT

A method for operating a longitudinally guiding driver assistance system of a motor vehicle, especially of an ACC system, which is designed to control the speed of a motor vehicle to a desired speed in a free travel mode and/or keeps a controlled distance to a vehicle in front as the control object in a follow mode, at least one control parameter influencing control being adapted depending on at least one item of traffic information that describes traffic conditions on the currently traveled route, especially in the further course of the route, information is received from an external transmitter.

The invention relates to a method for operating a longitudinally guiding driver assistance system of a motor vehicle, in particular an ACC system, which is configured for controlling the speed of a motor vehicle to a desired speed in a free travel mode and/or for controlling the speed of the motor vehicle for maintaining a controlled distance relative to a vehicle driving ahead as the control object. The invention also relates to a motor vehicle with such a driver assistance system.

Longitudinally guiding driver assistance systems for motor vehicles, which mostly automatically control the speed of the motor vehicle are already known in many configurations. The simplest configuration of such a longitudinally guiding driver assistance system is often referred to as speed control system (GRA) or cruise control. The speed of the motor vehicle is controlled to a speed that can be selected by the driver. These systems were enhanced, in particular under the name ACC system (Adaptive Cruise Control), by including a follow mode, which involves controlling to a fixed or driver-selectable control distance to the vehicle driving ahead as control object when the desired speed cannot be established due to a vehicle driving ahead, wherein often a defined time gap is used.

It is also known in so called pre-crash or emergency brake systems to carry out longitudinally guiding interventions in order to avoid a collision with an object and/or to mitigate consequences of a collision. Such emergency brake systems are safety systems, which use environmental sensors in order to determine the likelihood of a collision and when one or multiple threshold values are exceeded to carry out various measures, in particular braking interventions. Further measures include warning the driver, pre-conditioning of vehicle systems, in particular of the brake system, the seat belt system, the airbags and the like.

In the longitudinally guiding driver assistance systems known today, in particular also ACC or pre-crash systems with environmental sensor system, the reaction to events occurring in the area ahead are always the same. Mostly, an object in particular a control object is selected, based on which an intervention is performed in the motor vehicle. Disadvantageously, regarding the intervention it is thus not distinguished in which situation, in particular which in traffic situation, the vehicle is currently involved, which makes it difficult for the customer to understand the action of the driver assistance system, which appears improvable with regard to safety.

The invention is therefore based on the object to set forth a method for operating a driver assistance system, which is also responsive to special situations and traffic conditions.

For solving this object in a method of the aforementioned type it is provided according to the invention that at least one control parameter which influences the control is adjusted in dependence on at least one item of traffic information which is obtained by an external sender and which describes the traffic conditions on the actually driven on road, in particular along the future course of the road.

According to the invention it is proposed to use an externally received item of traffic information for example an item of traffic information which describes a traffic jam ahead and/or a dangerous situation ahead and/or the status of a traffic light ahead in order to re-parameterize the driver assistance system, in particular an ACC system, and/or an emergency brake system so that the driver assistance system is prepared for imminent traffic changes. For example when a traffic jam and/or a dangerous situation is reported, the driver assistance system can be prepared for the traffic jam because—in particular with regard to an ACC system—a fast deceleration may soon be expected.

The method according to the invention thus allows a situation-specific influence of a driver assistance system, in particular an ACC system and/or an emergency brake system, based on external items of traffic information in particular those received by radio, in particular traffic data or danger warnings so that the function can be optimized for the special situation. The behavior of the driver assistance system corresponds better to the expectations of the driver and a better reaction in dangerous situations is possible in particular also an increase of the safety of the driver assistance system.

It can concretely be provided that the item of traffic information is received by means of a communication device, in particular a radio receiver from the stationary and/or moving sender. This means that the present invention uses systems for receiving external traffic information currently summarized under “Car2X”-systems in which motor vehicles can exchange items of information with each other as well as with stationary communication devices using corresponding communication devices, wherein particularly advantageously a server is used as sender, which provides the traffic information to multiple motor vehicles. Expediently, the traffic information can be determined from, possibley processed, sensor data received by at least one further motor vehicle. This means, the server which eventually sends the traffic information collects data, in particular sensor data, from a multitude of motor vehicles on different roads and analyzes these data road-section- specifically in order to obtain useful traffic information for motor vehicles which for example can also be used in navigation systems in order to avoid traffic jams or the like. The road network is thus divided into different road sections which are each assigned at least one item of traffic information, which for example describes whether a traffic jam is present at this location, whether a dangerous situation is present or the like. Of course, an item of traffic information can also relate to a concrete location for example when it reflects the actual state of a traffic light, which can also act as a sender. It is noted that in particular a server that acts as a sender and contains traffic information relating to a traffic jam or dangerous situation, may not only determine these data from data of other motor vehicles but items of traffic information may for example also be obtained from the internet or from a local service for example a traffic monitoring system.

In a concrete embodiment of the present invention it can be provided that when an item of traffic information indicates a traffic jam ahead and/or a dangerous situation ahead, the penetration depth can be reduced, in particular to zero, when approaching a vehicle driving ahead and/or a maximal possible acceleration is reduced and/or a maximal possible deceleration is reduced and/or a merging-recognition for recognizing fast lane changes is re-parameterized, wherein in particular a plausibilization threshold is reduced and/or a control distance to the vehicle driving ahead is increased.

As already described, the driver assistance system, in particular an ACC-system, can be prepared for a traffic jam, thus the penetration depth can be reduced when approaching a vehicle driving ahead, for example also to a value of zero, slightly reducing comfort but enabling a faster reaction. The maximal acceleration with which to follow a vehicle driving ahead can also be reduced because in case of a traffic jam it can be assumed that if the vehicle ahead accelerates it will do so only for a short period of time. It is therefore also conceivable that a maximal deceleration is reduced so that a slower approach occurs. It is also possible that the merging-recognition can be re-parameterized because ahead of a traffic jam or in traffic jams other vehicles often change lanes. Thus the plausibilization threshold can be lowered, i.e., an individual that changes lanes can already become plausible as control object at a lower probability. It is further conceivable to increase the control distance to the vehicle driving ahead since the latter is expected to strongly brake when driving close to the traffic jam. Thus the driver assistance system adjusts to the traffic conditions and can adjust its function so that it offers the best driving behavior in particular with regard to safety.

In a further possible concrete embodiment of the method according to the invention it can be provided that when an emergency brake system is provided as driver assistance system and in case of an item of traffic information which indicates a dangerous situation ahead, in particular a person and/or an animal and/or an object on the road, that the classification threshold of standing objects which cannot be driven over is lowered and/or an intervention time point and/or a warning time point is shifted to an earlier time point. In an emergency brake system, the parameterizing can also be changed in case of an impending danger due to for example game, pedestrians or objects on the road or in case of a traffic jam. Thus the classification thresholds of standing objects, which cannot be driven over, can be lowered in order to enable a safe reaction or to enable a reaction in the first place, to standing objects. Intervention time points can also be moved forward in order to enable an earlier warning and intervention of the functions to imminent dangers and thus a better manageability of the critical situation.

In a further advantageous concrete embodiment of the present invention it can be provided that in case of an item of traffic information which indicates a red traffic light ahead, a plausibilization threshold for standing objects is lowered and/or the manner of approaching is adjusted to control parameters that describe standing objects, in particular with regard to a slow and/or more comfortable approach. Thus the item of information that standing objects are expected can advantageously be used in order to perform an appropriate re-parameterizing of the driver assistance system. It can further be provided to use knowledge about a red phase in order to influence the manner in which to approach standing (or very slow driving) objects, in particular also motor vehicles that wait in front of the traffic light. The gap thus is not to be closed particularly fast as is for example often desired in the case of ACC systems, but a longer time can be used so that in case of a longer red phase a comfortable closing of the gap is possible.

Beside the method, the invention also relates to a motor vehicle including a longitudinally guiding driver assistance system with a control device, which is configured for carrying out the method according to the invention. Thus, the motor vehicle can also have a communication device for receiving externally provided traffic information. All embodiments relating to the method according to the invention are analogously applicable to the motor vehicle according to the invention so that the advantages of the invention can also be attained with the motor vehicle according to the invention.

Further advantages and details of the present invention become apparent from exemplary embodiments described in the following and by way of the drawing. It is shown in:

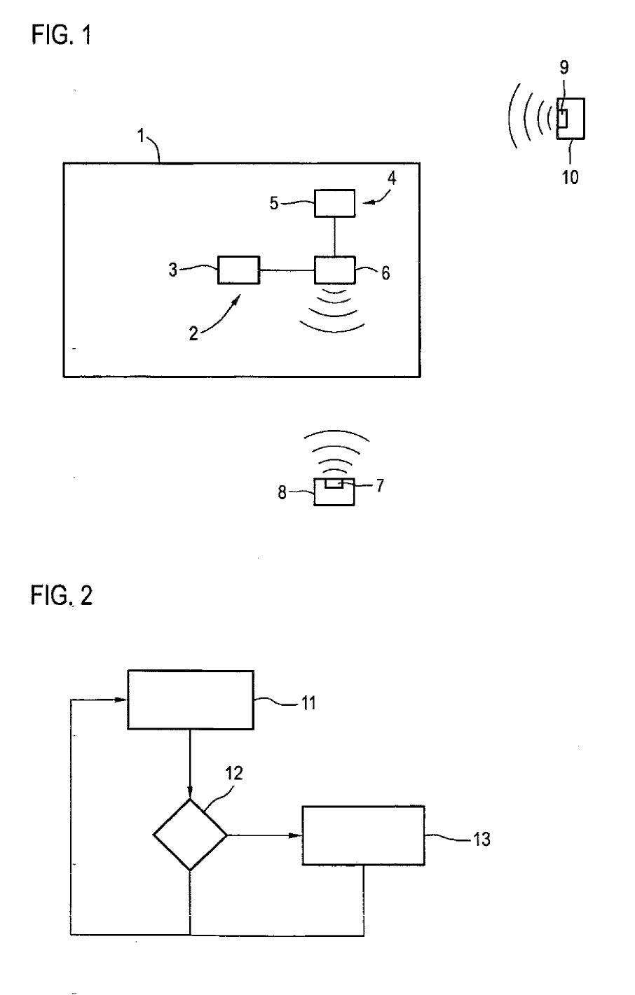

FIG. 1 a schematic diagram of a motor vehicle according to the invention and

FIG. 2 a flow chart of the method according to the invention.

FIG. 1 shows a schematic diagram of a motor vehicle 1 according to the invention. In the present case it has an ACC system 2 with a control device 3, which is configured for carrying out an embodiment of the method according to the invention. The motor vehicle 1 also has an emergency brake system 4 which also includes a control device 5, which carries out another embodiment of the method according to the invention.

Both control devices are connected with other vehicle systems, in particular via a CAN-bus, in particular with environmental sensors from which the data required for the function are obtained and with systems to be controlled, in particular a brake system and/or a motor. The other vehicle systems also include a communication device 6 which can for example be integrated into a radio of the motor vehicle 1. Via the communication device 6 data of an external stationary sender 7 can be received which is part of a server 8. On one hand, the server 8 receives data of different motor vehicles, in particular in the case when the motor vehicle 1 is also configured for sending data, also data of the motor vehicle 1, wherein these are mostly already processed sensor data. On the other hand, the server 8 also has access to further sources of information such as the internet or a local service. From all these items of information the server determines a site-specific and/or road section-specific item of traffic information, which in the present case indicates whether a traffic jam exists and/or a dangerous situation exists. In the present case, a further sender 9 is installed in a traffic light, wherein the sender 9 sends, i.e., broadcasts the actual state of the traffic light 10 as item of traffic information to the surrounding road users.

The respective control devices 3 and 5 now contain the traffic information provided by the communication device 6 and analyze the same in order to as the case may be allow a re-parameterization of the driver assistance systems 2, 4.

FIG. 2 shows as an overview the function of the method according to the invention. In a step 11, the actual item of traffic information is received by the communication device 6 and forwarded to the control devices 3 and 5. In a step 12, the actual item of traffic information is then analyzed by the control devices 3 and 5, wherein it is for example decided based on distances, or in case the traffic information is given on a scale, based on threshold values, whether control parameters of the driver assistance systems 2, 4 should be adjusted. When this is the case this adjustment occurs in a step 13. The method is then repeated whenever an actual item of traffic information can be received.

In the present case, when a traffic jam or a dangerous situation is ahead, i.e., in particular displayed on the road section on which the motor vehicle 1 is located, the penetration depth for the ACC-system 2 is reduced to zero when approaching a vehicle driving ahead, a maximal possible acceleration and a maximal possible deceleration are reduced and a merging-recognition is re-parameterized for recognizing fast lane changes in that a plausibilization threshold is lowered.

In the emergency brake system 4 the parameterizing is also changed in case of an impending danger due to game, pedestrians or objects on the road, in that classification thresholds of standing objects which cannot be driven over are lowered and intervention time points and warning time points are moved forward. In both systems, any time a red traffic light is indicated ahead within a defined range, the recognition of standing objects is accelerated in particular also in that plausibilization thresholds or the like are lowered. When a red phase of a traffic light is indicated, parameters that describe the approach-characteristics of the ACC system are adjusted so that the closing of the gap to standing objects (waiting vehicles) occurs slower and more comfortable since the possibility is given to “take time” at longer red phase.

Of course other adjustments of parameters for different traffic situations are conceivable to which the method according to the invention can be applied in order to optimize the function to the specific traffic situation.

1.-9. (canceled)

10. A method for operating a longitudinally guiding driver assistance system of a motor vehicle configured in at least one of two ways, a first way in which the longitudinally guiding driver assistance system is operated in a free travel mode to control a speed of the motor vehicle to a desired speed, a second way in which the longitudinally guiding driver assistance system is operated in a follow mode to control a speed of the motor vehicle to maintain a control distance to a vehicle driving ahead as control object, said method comprising:
adjusting at least one control parameter as a function of a traffic information received from an external sender and describing a current traffic condition on a road the motor vehicle drives on; and
when the traffic information indicates the presence of a traffic jam ahead or a dangerous situation ahead, adjusting the at least one control parameter in at least one of four ways,
a first way in which a penetration depth is reduced in relation to an approaching vehicle driving ahead,
a second way in which a maximal possible speed is lowered,
a third way in which a maximal possible deceleration is lowered,
a fourth way in which a merging-recognition for recognizing fast lane changes is re-prarameterized by lowering a plausibilization threshold so as to render a lane change as control object more plausible at a lower likelihood.

11. The method of claim 10, wherein the longitudinally guiding driver assistance system is constructed as ACC-system.

12. The method of claim 10, wherein the sender is stationary or mobile, with the traffic information being received by the sender via communication device.

13. The method of claim 12, wherein the sender is a radio receiver.

14. The method of claim 12, wherein the sender is constructed as a server.

15. The method of claim 14, wherein the traffic information on the server is determined as a function of sensor data received by at least one further motor vehicle, said sensor data optionally being processed.

16. The method of claim 10, wherein the traffic information indicates a traffic jam ahead, a dangerous situation ahead, or a status of a traffic light ahead.

17. The method of claim 10, wherein the driver assistance system is constructed as an emergency brake system, wherein, when the traffic information indicates a dangerous situation ahead, the at least one control parameter is adjusted so that classification thresholds of standing objects which cannot be driven over are lowered and/or an intervention time point and/or warning time point is moved to an earlier time point.

18. The method of claim 17, wherein the dangerous situation includes at least one of a person, an animal and an object on the road.

19. The method of claim 10, wherein when the traffic information indicates a red traffic light ahead a plausibilization threshold for a standing object is lowered or a control parameter which describes an approach-characteristic of the driver assistance system to standing objects is adjusted, in particular with regard to a slower and/or more comfortable approach.

20. The method of claim 10, wherein when the traffic information indicates a traffic jam ahead or a dangerous situation ahead the at least one control parameter is adjusted so as to lower the control distance to the vehicle driving ahead.

21. A motor vehicle, comprising:
a longitudinally guiding driver assistance system configured in at least one of two ways, a first way in which the longitudinally guiding driver assistance system is operated in a free travel mode to control a speed of the motor vehicle to a desired speed, a second way in which the longitudinally guiding driver assistance system is operated in a follow mode to control a speed of the motor vehicle to maintain a control distance to a vehicle driving ahead as control object; and
a control device configured to operate the longitudinally guiding driver assistance system, said control device being configured to
adjust at least one control parameter as a function of a traffic information received from an external sender and describing a current traffic condition on a road the motor vehicle drives on; and
when the traffic information indicates the presence of a traffic jam ahead or a dangerous situation ahead, to adjust the at least one control parameter in at least one of four ways,
a first way in which a penetration depth is reduced in relation to an approaching vehicle driving ahead,
a second way in which a maximal possible speed is lowered,
a third way in which a maximal possible deceleration is lowered,
a fourth way in which a merging-recognition for recognizing fast lane changes is re-prarameterized by lowering a plausibilization threshold so as to render a lane change as control object more plausible at a lower likelihood.

22. The motor vehicle of claim 21, wherein the longitudinally guiding driver assistance system is constructed as ACC-system.

23. The motor vehicle of claim 21, wherein the sender is stationary or mobile, with the traffic information being received by the sender via communication device.

24. The motor vehicle of claim 23, wherein the sender is a radio receiver.

25. The motor vehicle of claim 23, wherein the sender is constructed as a server.

26. The motor vehicle of claim 25, wherein the traffic information on the server is determined as a function of sensor data received by at least one further motor vehicle, said sensor data optionally being processed.

27. The motor vehicle of claim 21, wherein the traffic information indicates a traffic jam ahead, a dangerous situation ahead, or a status of a traffic light ahead.

28. The motor vehicle of claim 21, wherein the longitudinally guiding driver assistance system is constructed as an emergency brake system, and wherein, when the traffic information indicates a dangerous situation ahead, the at least one control parameter is adjusted so that classification thresholds of standing objects which cannot be driven over are lowered and/or an intervention time point and/or warning time point is moved to an earlier time point.

29. The motor vehicle of claim 28, wherein the dangerous situation includes at least one of a person, an animal and an object on the road.
